(19) United States
(12) Patent Application Publication
(10) Pub. No.: US 2005/0289523 A1
(43) Pub. Date: Dec. 29, 2005

(54) Method and apparatus for transforming code of a non-proprietary program language into proprietary program language

(75) Inventors: Evgeny Spektor, Petach-Tikva (IL); Eli Arad, Givat Smoel (IL)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 11/105,393

(22) Filed: Apr. 14, 2005

Related U.S. Application Data
(60) Provisional application No. 60/582,222, filed on Jun. 24, 2004.

(51) Int. Cl. G06F 9/45

(52) U.S. Cl. 717/140

(57) ABSTRACT

The invention relates to a method comprising the steps of: (a) providing of software code written in a non-proprietary software program language; and (b) compiling said software code into a software code written in a different, proprietary software program language, wherein said compiled software code is of a first format; and (c) parsing said compiled software code to transform it to a second format.

### CROSS REFERENCE TO RELATED APPLICATIONS

This application claims the benefit of U.S. Provisional Application No. 60/582,222, filed on Jun. 24, 2004, entitled “Compiler to Transform C-Code Program Language into Assembler Program Language” which is incorporated by reference herein in its entirety.

### FIELD OF THE INVENTION

The present invention relates generally to an apparatus and a method, more particularly, to a method for transforming code written in one specific non-proprietary software program language into code written in a different, proprietary software program language.

### BACKGROUND OF THE INVENTION

In digital video and/or video/audio systems such as video-telephone, teleconference and digital television systems, a large amount of digital data is needed to define each video frame signal since a video line signal in the video frame signal comprises a sequence of digital data referred to as pixel values.

Since, however, the available frequency bandwidth of a conventional transmission channel is limited, in order to transmit the large amount of digital data therethrough, it is necessary to compress or reduce the volume of data through the use of various data compression techniques, e.g. as defined in a respective MPEG standard (i.e. a digital coding standard as defined by the Moving Picture Expert Group).

One of such techniques for encoding video signals for a low bit-rate encoding system is an object-oriented analysis-synthesis coding technique, wherein an input video image is divided into objects and three sets of parameters for defining the motions, the contours, and the pixel data of each object are processed through different encoding channels.

One example of such object-oriented coding scheme is the so-called MPEG (Moving Picture Experts Group) phase 4 (MPEG-4), which is designed to provide an audio-visual coding standard for allowing content-based interactivity, improved coding efficiency and/or universal accessibility in such applications as low-bit rate communications, interactive multimedia (e.g., games, interactive TV and the like) and surveillance (see, for instance, MPEG-4 Video Verification Model Version 2.0, International Organization for Standardization, ISO/IEC JTC1/SC29/WG11 N1260, March 1996).

According to MPEG-4, an input video image is divided into a plurality of video object planes (VOP's), which correspond to entities in a bitstream that a user can have access to and manipulate. A VOP can be referred to as an object and represented by a bounding rectangle whose width and height may be chosen to be smallest multiples of 16 pixels (a macro block size) surrounding each object so that the encoder processes the input video image on a VOP-by-VOP basis, i.e., an object-by-object basis. The VOP includes color information consisting of the luminance component (Y) and the chrominance components (Cr, Cb) and contour information represented by, e.g., a binary mask.

Also, among various video compression techniques, the so-called hybrid coding technique, which combines temporal and spatial compression techniques together with a statistical coding technique, is known.

Most hybrid coding techniques employ a motion compensated DPCM (Differential Pulse Coded Modulation), two-dimensional DCT (Discrete Cosine Transform), quantization of DCT coefficients, and VLC (Variable Length Coding). The motion compensated DPCM is a process of estimating the movement of an object between a current frame and its previous frame, and predicting the current frame according to the motion flow of the object to produce a differential signal representing the difference between the current frame and its prediction.

Specifically, in the motion compensated DPCM, current frame data is predicted from the corresponding previous frame data based on an estimation of the motion between the current and the previous frames. Such estimated motion may be described in terms of two dimensional motion vectors representing the displacements of pixels between the previous and the current frames.

There have been two basic approaches to estimate the displacements of pixels of an object. Generally, they can be classified into two types: one is a block-by-block estimation and the other is a pixel-by-pixel approach.

The above-mentioned (and/or other) video and/or audio data processing algorithms and/or procedures, e.g., respective MPEG algorithms and/or procedures, etc. often are performed in software.

The respective software code might be stored e.g. on a respective memory unit. The software code—when executed on one or several processing units—causes the processing unit(s) to perform the above or other algorithms and/or procedures, in particular, respective MPEG algorithms and/or procedures.

The respective software code might e.g. be written in a specific assembler program language, in particular, a respective proprietary assembler program language (e.g., in an assembler program language only using specific instructions contained in the instruction set of a specific processing unit). However, assembler programming is quite complex. Further, the assembler program might only be used for one specific processing unit, and not for further, different processing units using a different set of instructions.

Therefore, what is needed is new system and/or a new method with which the above and/or other drawbacks of the prior art might be overcome.

Further limitations and disadvantages of conventional and traditional approaches will become apparent to one of skill in the art, through comparison of such systems and methods with the present invention as set forth in the remainder of the present application with reference to the drawings.

### SUMMARY OF THE INVENTION

According to an aspect of the invention, a method is provided comprising the steps of:

(a) providing of software code written in a non-proprietary software program language; and

(b) compiling said software code into a software code written in a different, proprietary software program language, wherein said compiled software code is of a first format; and

(c) parsing said compiled software code to transform it to a second format.

Preferably, the non-proprietary software program language is a C type program language such as (regular) C, C++, C#, C*, GNU-C, COOL, OBJECTIVE C, or other derivatives. On the other hand, it is not restricted to the C type of program languages but can be any other suitable language like ABEL, ALEPH, FORTRAN, MODULA-2, BASIC, OBERON, and so on.

Preferably, the C program language is used for MPEG encoding and/or decoding and, also preferably, contains special adaptions to accomodate for this task such as special library routines, macros, and so on. Preferably, the program language used is of a ‘mixed C’ type, i.e. regular C code mixed with macros for unique instructions.

Preferably, the different, proprietary software program language is an assembler program language.

Then, preferably, the assembler program language is a program language suited for a graphics/video processing chip(s) that, if required, can also process other multimedia data like audio data. Graphic processing chips may contain special instructions w.r.t. to their tasks, e.g. regarding bit manipulation, bitstream generation, time sampling and so on. These special instructions may be cared for on the non-proprietary language level using the above-mentioned macros of the ‘mixed C’ type program language.

The graphics/video processing chips can use, e.g., Nvidia, ATI, S3, MGA, Tseng Labs, Cirrus, TI, or—preferably—Broadcom assembler language, and so forth. In particular, the assembler program language is used on a Broadcom BCM 7042 chip (and/or e.g. the Broadcom BCM 7040 and/or 7041 chip), and so on. The processing chips can be, e.g., part of a graphics/video card or a set-top box, for example part of a personal video recorder using MPEG-Coding.

Preferably, the software code written in the non-proprietary software program language is being compiled into the code written in the different, proprietary software program language by a compiler that uses a special machine description file that describes the (proprietary) specific processor architecture (e.g. number of registers, ALU operations, memory type and size, etc.). For different processors may be provided different description files so that the compiler is advantageously flexible.

The compiler may be a GNU-C compiler. Then, the compiled software code is in a non-proprietary software program language code that has a first format, which in this embodiment is of a GNU format. Using a different compiler may lead to a different first format of the compiled software code.

Preferably, parsing said compiled software code that is in a first format to transform it to a second format is performed by a special parser. For example, using a GNU compiler may lead to a temporary assembler file in the first format that is a GNU format. The first format contains the assembler instructions and data etc. but not in the exact assembler format used by the respective processor. The parser transforms the temporary assembler file into a final assembler file containing software code of the second format. The second format is such that it can be directly used with appropriate assemblers/assembler units. The parsing can be performed by a parsing means different from the compiling means, or by an integrated process, e.g. using a joint compiling/parsing means.

According to another aspect of the invention, an apparatus is provided comprising compiling means for compiling software code written in a non-proprietary software program language into a code of a first format written in a different, proprietary software program language; and parsing means for transforming the compiled software code of a first format to a second format.

In an embodiment, the apparatus comprises a computer having stored thereon a respective compiler for compiling the software code written in the non-proprietary software program language into the software code written in the different, non-proprietary software program language. At this stage, the software code may be of a first format

The respective non-proprietary software code transformed/compiled by the above apparatus, e.g. computer, and written in the above different proprietary software program language, e.g. assembler program language, of a first format might then be stored, e.g. on one or several memory units of an electronic system, and/or a chip.

The parsing means transforms the compiled—thus proprietary—program code into a second format, i.e. as a final assembler file, that can be directly read and executed by an assembler means, e.g. transformed further into machine-readable code. The final assembler file and/or the machine-readable code can also be stored in a similar manner as described above. The parsing can be performed by a special parser/parsing means, e.g. a parsing computer program.

The software code of the second format—when executed on one or several processing units of the system or chip, possibly requiring an assembler—causes the processing unit(s) to perform e.g. a respective video and/or audio data processing algorithm and/or procedure, or any other kind of algorithm and/or procedure, in particular, respective MPEG algorithms and/or procedures.

Thus, in summary, the present invention might e.g. provide a less complex and/or more flexible programming of video and/or audio data processing algorithms and/or procedures, in particular, MPEG algorithms and/or procedures.

The present invention also relates to a software program product, e.g. a disc, CD, DVD, or set thereof, and so on, of which the software code of the compiler and/or the parser is stored.

These and other advantages, aspects and novel features of the present invention, as well as details of an illustrated embodiment thereof, will be more fully understood from the following description and drawings.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an apparatus with which a method according to an embodiment of the invention can be performed.

FIG. 2 illustrates a motherboard mounted into the apparatus of FIG. 1, comprising a CPU, and respective memory components.

FIG. 3 illustrates a video and/or audio data processing chip on which software code generated by the apparatus in FIG. 1 is stored and executed.

FIG. 4 shows a block diagram of the method according to of an embodiment the invention.

FIG. 5 shows a block diagram of the different kinds of forms of source code according to an embodiment of the invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known processes and steps have not been described in detail in order not to unnecessarily obscure the present invention.

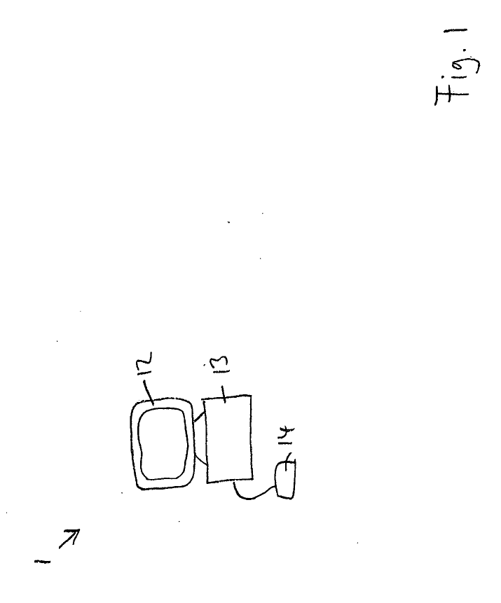

In FIG. 1 there is shown an apparatus 1, e.g. a PC (personal computer), a workstation, or any other kind of computer with which a method according to an embodiment of the invention can be performed.

Into a housing 13 of the apparatus 1, a respective motherboard 11 might be mounted, comprising e.g. one or several CPUs 2, a co-processing component (CoPro 3), a quartz or crystal oscillator 5, several plug-in places or card slots 8, and several memory components, e.g., cache memory components 6, a RAM-BIOS component 7, several memory banks 9, etc., and a Direct Memory Access component (DMA 4).

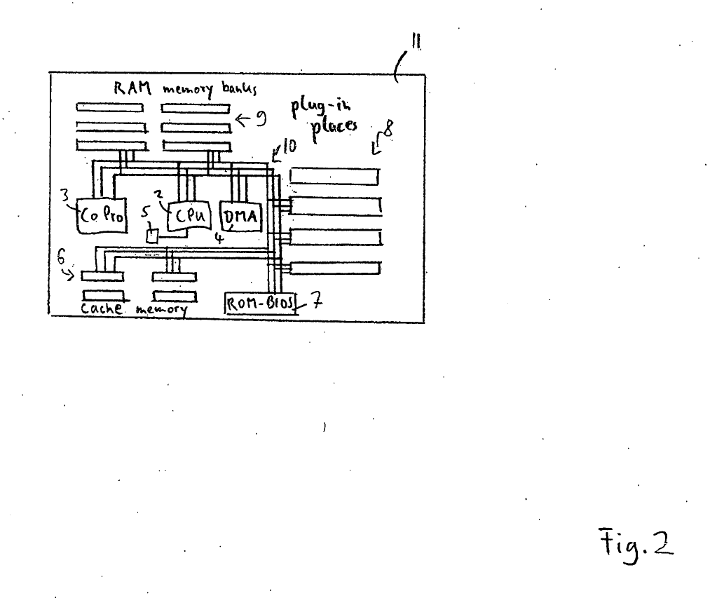

As can be seen from FIG. 2, the several components of the motherboard 11 are linked by one or several bus systems comprising e.g. respective data, address, and/or control buses, e.g., a PCI bus system 10.

Further, into the above memory bank 9, one or several SIMM modules can be plugged, each carrying several RAM components, e.g., respective DRAM (or VRAM) memory chips.

In addition, into the plug-in places—optionally—one or several peripheral component cards can be plugged in, e.g., respective sound cards, video data processing cards, graphic data processing cards, modem cards, etc.

For example, a graphic data processing card (which might e.g. comprise one or several non-programmable data processing chips, e.g. GPUs, and one or several memory chips, etc.), might e.g. control the data interchanged between one or several components on the motherboard 11, and a monitor (e.g. the monitor 12 shown in FIG. 1).

As can be seen in FIG. 1, the apparatus 1 further comprises respective input means, e.g., a keyboard 14 (and/or a mouse (not shown)).

On one or several of the above (or other) memory components, a software developing tool (i.e., a respective software) might be stored, which—when executed on the CPU 2—allows a user of the apparatus 1 to write, test, and/or amend a respective (new) software program.

The (new) software program might be written in a non-proprietary software program language, for instance, in C or ‘mixed C’.

For example, by use of the apparatus 1 (and the above software developing tool), a C type software code used for MPEG encoding/decoding algorithms and/or processes might be programmed.

In addition, on one or several of the above (or other) memory components, a further software, in particular, a compiler program might be stored, which—when executed on the CPU 2—allows a user of the apparatus 1 to automatically transform the above C or ‘mixed C’ software code into a code written in a different, proprietary software program language, and to store the generated—different—code on one or several of the above (or other) memory components.

Alternatively, this function might also be fulfilled by the above software developing tool.

The above different, proprietary software program language might be a temporary assembler program language of a first format that is determined by the type of compiler. If the compiled software code of the first format—i.e. a temporary assembler file—is not be directly machine-readable or readable by an assembler unit it must be transformed into a second format that is of the final assembler format. The compiler may also directly generate a machine-readable code or final assembler code of the second format.

For instance, the final assembler code generated by the apparatus 1 might be in an assembler program language used on a Broadcom BCM 7042 chip (and/or e.g. the Broadcom BCM 7040 and/or 7041 chip), etc.

After generating the final assembler code or machine-readable code, alternatively, this code might again be tested (e.g., by carrying out respective simulation procedures), and/or amended.

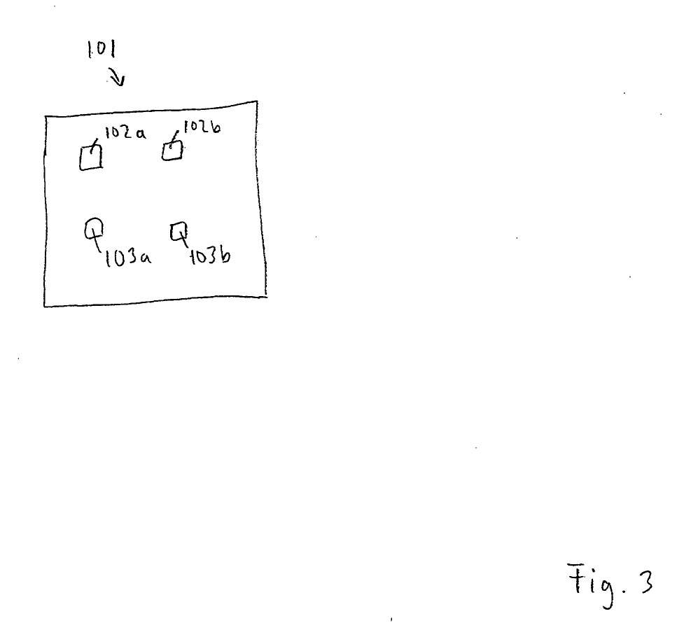

Finally, the data referring to the generated (and/or amended) assembler code might be stored on one or several memory units 102a, 102b of a respective video and/or audio data processing chip 101 shown in FIG. 3, in particular, a respective MPEG chip (and on respective memory units of many further video and/or audio data processing chips corresponding to the chip 101 shown in FIG. 3).

The video and/or audio data processing chip 101 (e.g., a Broadcom BCM 7042 chip (and/or e.g. the Broadcom BCM 7040 and/or 7041 chip, etc.)), comprises one or several processing units 103a, 103b (e.g., more than two or three processing units).

The final assembler software code—when executed on the one or several processing units 103a, 103b—causes the processing unit(s) 103a, 103b to perform e.g. a respective video and/or audio data processing algorithm and/or procedure, or any other kind of algorithm and/or procedure, in particular, respective MPEG algorithms and/or procedures.

If the software is to be used on chips different from the chip 101 shown in FIG. 3, e.g. a chip which uses an assembler language different from the assembler language mentioned above, the above compiler program stored on the apparatus 1 might—in an alternative embodiment—when executed on the CPU 2 also allow the user of the apparatus 1 to automatically transform the above C software code not into the above-mentioned assembler program, but—alternatively—also into a program, in particular an assembler program different therefrom (which might be used on the above—different—chip).

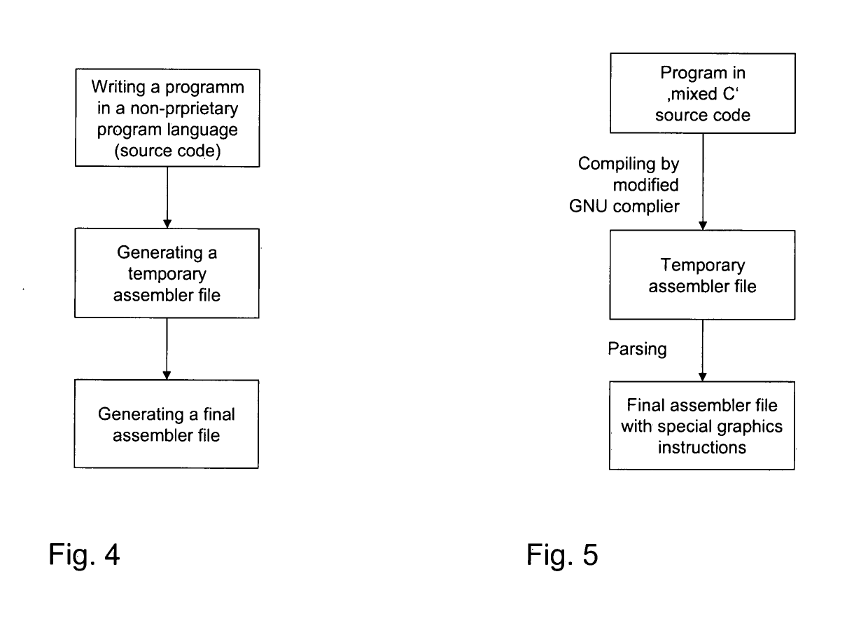

In FIG. 4 are shown three steps of a processing a software code by the method of the invention. In a first step a software code (source code) is written/provided in a non-proprietary language, preferably a C type language. Then, this source code is transformed into a temporary assembler code/file of a format that is particular to the output format of the respective transformer/compiler. The temporary assembler file contains the necessary instructions and data for the processing unit (Graphics Processing Unit and such) but in this embodiment not in a format that is directly readable by the processor and its assembler, resp. Therefore, the temporary assembler file is transformed into a final assembler file by parsing. The parsing process analyses the instructions and data etc. and its syntax, and then rearranges the temporary assembler file into a second/final format that is readable by the processor and its assembler, resp. In this embodiment, the first format is an output format of a GNU-C compiler, and the final assembler file is suitable for a Broadcom, Inc. graphics chip/processor.

FIG. 5 shows three steps of the software code according to the invention similar to FIG. 4. Firstly, a source code in a non-proprietary software language—in this embodiment in a ‘mixed C’ language—has been written. This source code is transformed into a temporary assembler file by compiling it by the means of a GNU-C compiler that is modified to accommodate for special macros describing special graphics functions. The compiler uses a special machine description file to accommodate for the special structure and instructions of the particular processor. By exchanging the special machine description file, the compiler can be easily used/reconfigured for other processors

The temporary assembler file is of a first format not directly compatible to the assembler format required by the processor. Then, the temporary assembler file is parsed by a special parser to transform the temporary assembler file into a final assembler file that is in a second format compatible with the assembler syntax/format required by the processor.

Thus, in summary, the present invention might e.g. provide a less complex and/or more flexible programming of video and/or audio data processing algorithms and/or procedures, in particular, MPEG algorithms and/or procedures.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method comprising the steps of:
(a) providing a software code written in a non-proprietary software program language; and
(b) compiling said software code into a software code written in a different, proprietary software program language, wherein said compiled software code is of a first format; and
(c) parsing said compiled software code of said first format to transform it to a second format.

2. The method of claim 1, wherein said non-proprietary software program language is a C program language.

3. The method of claim 2, wherein said C program language is used for MPEG encoding/decoding.

4. The method of claim 1, wherein said different, proprietary software program language is an assembler program language.

5. The method of claim 4, wherein said assembler program language of said second format is a Broadcom assembler language.

6. The method of claim 1, wherein said compiling of step (b) is performed by a compiler using a special machine description file.

7. An apparatus, comprising compiling means for compiling software code written in a non-proprietary software program language into a code of a first format written in a different, proprietary software program language; and parsing means for transforming the compiled software code of a first format to a second format.

8. The apparatus of claim 7, comprising a computer having stored thereon a respective compiler for compiling said software code written in said non-proprietary software program language into said software code written in said different, non-proprietary software program language.

9. The apparatus of claim 8, wherein said compiler works with a special machine description file.
